(19) United States
(12) Patent Application Publication
(10) Pub. No.: US 2023/0229953 A1
(43) Pub. Date: Jul. 20, 2023

(54) COMPUTER SYSTEM AND CONTROL DEVICE

(71) Applicant: NATIONAL INSTITUTE OF ADVANCED INDUSTRIAL SCIENCE AND TECHNOLOGY, Tokyo (JP)

(72) Inventor: Daisuke SAIDA, Tsukuba-shi (JP)

(73) Assignee: NATIONAL INSTITUTE OF ADVANCED INDUSTRIAL SCIENCE AND TECHNOLOGY, Tokyo (JP)

(21) Appl. No.: 18/001,453

(22) PCT Filed: Jun. 4, 2021
(86) PCT No.: PCT/JP2021/021357

§ 371 Date: Dec. 9, 2022

(30) Foreign Application Priority Data
Jun. 30, 2020 (JP) 2020-112273

(51) Int. Cl. G06N 10/40

(52) U.S. Cl. CPC G06N 10/40

(57) ABSTRACT

Provided are a computer system and a control device, which are capable of reducing the necessity for reconfiguration according to the computation details in the circuit configuration of a quantum computer. The computer system includes an acquisition unit 122 that acquires computation details; a group of computation units including a plurality of computation units each configured to execute computation using quantum effects or thermal effects in a superconducting state; a selection unit 124 that selects a computation unit from the group of computation units based on the computation details; and an execution unit 212 that causes the computation unit selected by the selection unit to execute computation.

### TECHNICAL FIELD

The present invention relates to a computer system and a control device.

### BACKGROUND ART

In recent years, development for implementing a quantum computer utilizing quantum mechanical effects has been made. For example, Patent Document 1 discloses a quantum computer using a superconducting device.

### CITATION LIST

### Patent Document

Patent Document 1: Japanese Translation of PCT Application No. 2011-524026

### SUMMARY

### Technical Problem

The quantum computer requires a circuit configuration according to computation details. Thus, in the conventional quantum computer, change of the computation details requires the circuit configuration of the quantum computer to be reconfigured according to the computation details. As a result, the user may have to bear a burden therefor.

With the foregoing in view, an object of the present invention is to provide a computer system and a control device, which are capable of reducing the necessity for reconfiguration according to the computation details in the circuit configuration of a quantum computer.

### Solution to Problem

A computer system according to an aspect of the present invention includes: an acquisition unit that acquires computation details; a group of computation units including a plurality of computation units each configured to execute computation using quantum effects or thermal effects in a superconducting state; a selection unit that selects a computation unit from the group of computation units based on the computation details; and an execution unit that causes the computation unit selected by the selection unit to execute computation.

According to this aspect, a computation unit according to computation details is selected, and the computation unit executes computation. As a result, the necessity for reconfiguration according to the computation details in the circuit configuration of a quantum computer is reduced.

In the aspect, the group of computation units may include a general-purpose computation unit that is a computation unit for general purposes and a specific computation unit that is a computation unit for a specific purpose, and the selection unit may select the general-purpose computation unit if the group of computation units does not include a specific computation unit for a purpose matching the computation details, and select the specific computation unit if the group of computation units includes a specific computation unit for a purpose matching the computation details.

According to this aspect, a more appropriate computation unit is selected according to the computation details.

In the aspect, the group of computation units may include a plurality of specific computation units for different purposes, and the selection unit may select a specific computation unit for a purpose matching the computation details.

According to this aspect, a more appropriate computation unit is selected according to the computation details.

In the aspect, the group of computation units may include a plurality of computation units formed on the same board.

According to this aspect, design becomes easier than when the plurality of computation units are formed on different boards in some cases.

In the aspect, the group of computation units may include a plurality of computation units formed on different boards.

According to this aspect, it is possible to place a plurality of computation units at appropriate positions, respectively.

In the aspect, the plurality of computation units formed on different boards may include a plurality of computation units formed on boards of different temperatures, and each of the plurality of computation units formed on the boards of different temperatures may be formed on the board of a temperature appropriate for computation by each computation unit.

According to this aspect, it is possible to utilize space inside a refrigerator more efficiently when a computation unit is placed in the refrigerator or the like.

In the aspect, the selection unit may select a plurality of computation units from the group of computation units, and the execution unit may cause each of the plurality of computation units selected by the selection unit to execute computation.

According to this aspect, it is possible to cause a plurality of computation units to execute computation.

In the aspect, the execution unit may cause each of the plurality of computation units selected by the selection unit to execute computation such that computations executed by the respective plurality of computation units selected by the selection unit become asynchronous to each other.

According to this aspect, it is possible to cause a plurality of computation units to execute computations at respective timings.

In the aspect, the execution unit may cause each of the plurality of computation units selected by the selection unit to execute computation such that computations executed by the respective plurality of computation units selected by the selection unit become synchronous to each other.

According to this aspect, it is possible to manage the timing of executing computation by each of the plurality of computation units.

A control device according to another aspect of the present invention includes: an acquisition unit that acquires computation details; and a selection unit that selects, based on the computation details, a computation unit from a group of computation units including a plurality of computation units each configured to execute computation using quantum effects or thermal effects in a superconducting state.

According to this aspect, a computation unit according to computation details is selected, and the computation unit executes computation. As a result, the necessity for reconfiguration according to the computation details in the circuit configuration of the quantum computer is reduced.

In the aspect, the group of computation units may include a general-purpose computation unit that is a computation unit for general purposes and a specific computation unit that is a computation unit for a specific purpose, and the selection unit may select the general-purpose computation unit if the group of computation units does not include a specific computation unit for a purpose matching the computation details, and select the general-purpose computation unit if the group of computation units includes a specific computation unit for a purpose matching the computation details.

According to this aspect, a more appropriate computation unit is selected according to the computation details.

In the aspect, the group of computation units may include a plurality of specific computation units for different purposes, and the selection unit may select a specific computation unit for a purpose matching the computation details.

According to this aspect, a more appropriate computation unit is selected according to the computation details.

### Advantageous Effects of Invention

According to the present invention, it is possible to provide a computer system and a control device, which are capable of reducing the necessity for reconfiguration according to the computation details in the circuit configuration of a quantum computer.

### BRIEF DESCRIPTION OF DRAWINGS

FIG. 1 is a schematic configuration diagram of a computer system according to an embodiment of the present disclosure.

FIG. 2 is a diagram illustrating an example of a hardware configuration of a control device according to the embodiment.

FIG. 3 is a schematic configuration diagram of a measurement device and a refrigerator according to the embodiment.

FIG. 4 is a schematic configuration diagram of a general-purpose computation unit according to the embodiment.

FIG. 5 is a flow chart illustrating a flow of processing to be executed by the computer system according to the embodiment.

FIG. 6 is a diagram illustrating the result of NOR operation by a NOR unit in an example 1.

FIG. 7 is a diagram for describing computation details of a multiplier unit in the example 1.

FIG. 8 is a diagram illustrating the result of multiplication by the multiplier unit in the example 1.

FIG. 9 is a diagram illustrating currents flowing through three circuits in simulation of an example 2.

FIG. 10 is a diagram illustrating currents flowing through three quantum bit loops in simulation of the example 2.

FIG. 11 is a diagram illustrating the result of simulation that reproduces computation by the computation unit in the example 2.

FIG. 12 is a diagram illustrating the configurations of two boards according to a first modification example.

FIG. 13 is a diagram illustrating the internal configuration of a refrigerator according to a second modification example.

FIG. 14 is a diagram illustrating the configurations of two measurement devices and a board according to a third modification example.

FIG. 15 is a schematic configuration diagram of a computer system according to a fourth modification example.

### DESCRIPTION OF EMBODIMENTS

Now, preferred embodiments of the present invention are described with reference to the drawings. In the drawings, the same reference symbol indicates the same or similar component.

### First Embodiment

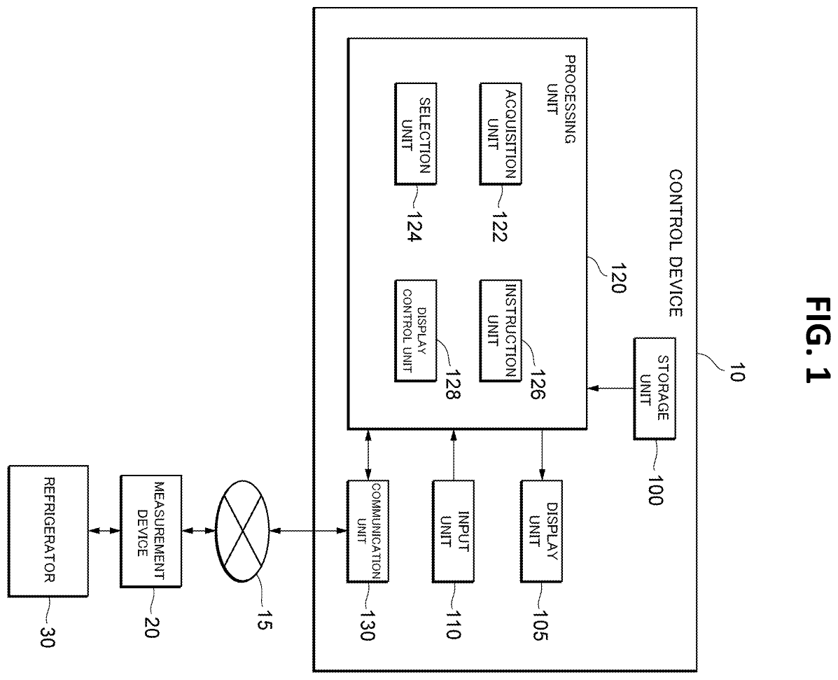

FIG. 1 is a schematic configuration diagram of a computer system 1 according to an embodiment of the present disclosure. The computer system 1 according to this embodiment mainly comprises a control device 10, a measurement device 20, and a refrigerator 30. The control device 10 and the measurement device 20 are communicably connected to each other via a communication network 15. Further, the measurement device 20 is connected to a plurality of computation units placed in the refrigerator 30.

The communication network 15 may be configured in various kinds of forms. The communication network 15 may be, for example, a data transfer network (WAN) or a local area network (LAN) that connects components to each other via a dedicated line. In this embodiment, description is given on the assumption that the communication network 15 is the Internet, which is a representative public network. The control device 10 and the measurement device 20 may be connected to each other via a universal serial bus (USB) cable, a general purpose interface bus (GPIB) cable, or the like.

In the refrigerator 30, a group of computation units including a plurality of computation units each configured to execute computation using quantum effects or thermal effects in a superconducting state is placed. In this embodiment, the group of computation units serves as a quantum computer. The control device 10 can select a computation unit that executes computation from the group of computation units placed in the refrigerator 30. The measurement device 20 causes the computation unit selected by the control device 10 to execute various kinds of computations. Now, the configurations of the control device 10, the measurement device 20, and the refrigerator 30 are described in detail.

The control device 10 can select a computation unit based on computation details, and give an instruction to the measurement device 20 such that the selected computation unit executes computation. The control device 10 comprises a storage unit 100, a display unit 105, an input unit 110, a processing unit 120, and a communication unit 130.

The storage unit 100 stores various kinds of information. The storage unit 100 stores, for example, information for selecting a computation unit. Specifically, the storage unit 100 may store a table associating a computation unit with the purpose (purpose such as factorization or protein structure analysis) of the computation unit. In this embodiment, the table stores information indicating a plurality of computation units and information indicating a purpose associated with each of the plurality of computation units. The processing unit 120 refers to various kinds of information stored in the storage unit 100 as necessary.

The display unit 105 can display various kinds of screens. For example, the display unit 105 can display a screen for specifying computation details. Specifically, the display unit 105 displays various kinds of computation details, and displays a screen enabling a user to specify computation details in various forms such as a checkbox, scrolling, and pull-down.

The input unit 110 receives input of various kinds of information according to operation performed by the user. For example, the input unit 110 receives computation details according to operation performed by the user. In this case, the input unit 110 may receive a plurality of computation details. Various kinds of information received by the input unit 110 are transmitted to the processing unit 120.

The processing unit 120 executes various kinds of processing. Specifically, the processing unit 120 can select a computation unit from the group of computation units, and give an instruction to the measurement device 20 such that the selected computation unit executes computation. The processing unit 120 includes an acquisition unit 122, a selection unit 124, an instruction unit 126, and a display control unit 128.

The acquisition unit 122 can acquire various kinds of information. Specifically, the acquisition unit 122 can acquire various kinds of information from the storage unit 100, or can acquire various kinds of information received by the input unit 110. For example, the acquisition unit 122 can acquire computation details from the input unit 110 based on operation performed by the user. In this case, the acquisition unit 122 may acquire a plurality of computation details.

The selection unit 124 can select a computation unit from the group of computation units placed in the refrigerator 30 based on the computation details acquired by the acquisition unit 122. Specifically, the selection unit 124 refers to the table stored in the storage unit 100 to select a computation unit that according to the acquired computation details. In this embodiment, the group of computation units includes a general-purpose computation unit that is a computation unit for general purposes, and a specific computation unit that is a computation unit for a specific purpose. The selection unit 124 selects at least one of the general-purpose computation unit and the specific computation unit according to the computation details.

Specifically, if the group of computation units does not include a specific computation unit for a purpose matching the acquired computation details, the selection unit 124 selects the general-purpose computation unit. On the other hand, if the group of computation units includes a specific computation unit for a purpose matching the acquired computation details, the selection unit 124 selects the specific computation unit.

Further, the selection unit 124 can select a plurality of computation units from the group of computation units. The selection unit 124 may select a plurality of specific computation units, or select the general-purpose computation unit and at least one specific computation unit. In this case, the selection unit 124 can use the plurality of computation details to select a computation unit for a purpose matching each of the plurality of computation details. Alternatively, the selection unit 124 may use one set of computation details to select a plurality of computation units matching the one set of computation details. That is, computation according to the one set of computation details may be distributed across a plurality of computation units.

The instruction unit 126 can give an instruction to execute computation by a computation unit. Specifically, the instruction unit 126 can transmit various kinds of signals to the measurement device 20 via the communication unit 130, and give an instruction to execute computation by a computation unit. In this embodiment, the instruction unit 126 gives an instruction to execute computation by the computation unit selected by the selection unit 124. Further, the instruction unit 126 may give an instruction indicating the number of times of executing computation by a computation unit based on operation performed by the user, for example.

Further, the instruction unit 126 can give an instruction to execute computations by a plurality of computation units. In this case, the instruction unit 126 can give an instruction relating to synchronization of computations by a plurality of computation units. For example, the instruction unit 126 may give an instruction indicating the timing of computation by each of a plurality of computation units based on operation performed by the user.

The display control unit 128 controls display of the display unit 105. Specifically, the display control unit 128 generates data of a screen to be displayed by the display unit 105, and transmits the generated data to the display unit 105. For example, the display control unit 128 can generate data of various kinds of screens for inputting computation details by the user, and transmit the generated data to the display unit 105.

The communication unit 130 can transmit and receive various kinds of information. For example, the communication unit 130 can transmit the instruction from the instruction unit 126 to the measurement device 20 via the communication network 15.

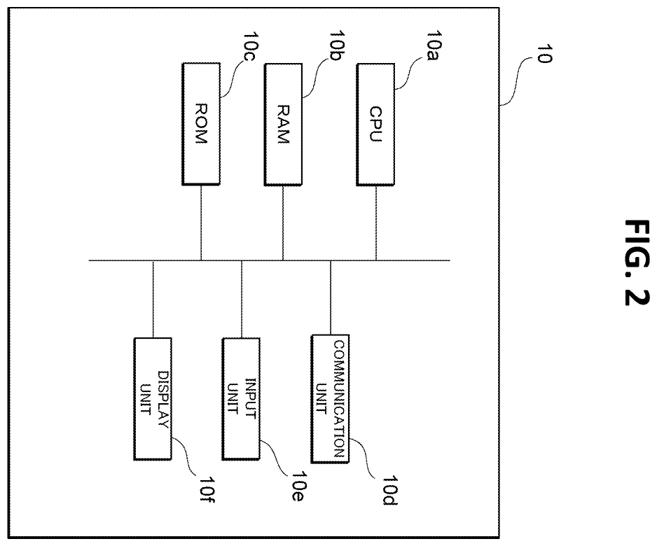

FIG. 2 is a diagram illustrating an example of a hardware configuration of the control device 10 according to this embodiment. The control device 10 includes a central processing unit (CPU) 10a corresponding to the processing unit 120, a random access memory (RAM) 10b corresponding to the storage unit 100, a read only memory (ROM) 10c corresponding to the storage unit 100, a communication unit 10d, an input unit 10e, and a display unit 10f. These components are connected to one another via a bus so as to enable transmission/reception of data. In this example, description is given of a case in which the control device 10 is constructed by one computer, but the control device 10 may be implemented by a combination of a plurality of computers. Further, the configuration illustrated in FIG. 2 is an example, and the control device 10 may have a configuration other than the configuration described above, or may not have a part of the configuration described above.

The CPU 10a is a processing unit that controls execution of a program stored in a RAM 10b or a ROM 10c, or computes and processes data. The CPU 10a is a processing unit that acquires computation details, selects a computation unit, and executes a program (computation instruction program) for giving an instruction to execute computation. The CPU 10a receives various kinds of data from the input unit 10e or the communication unit 10d, and displays the result of computing the data on the display unit 10f or stores the result into the RAM 10b.

The RAM 10b is a storage unit that enables rewrite of data, and may be constructed by a semiconductor memory device, for example. The RAM 10b may store data such as a program to be executed by the CPU 10a, a computation result, and data necessary for computation. These pieces of data are merely examples, and the RAM 10b may store data other than these pieces of data or may not store a part of these pieces of data.

The ROM 10c is a storage unit that enables read of data, and may be constructed by a semiconductor memory device, for example. The ROM 10c may store, for example, a computation instruction program or unrewritable data.

The communication unit 10d is an interface for connecting the control device 10 to other devices. The communication unit 10d may be connected to a communication network such as the Internet.

The input unit 10e receives input of data from the user, and may include a keyboard and a touch panel, for example.

The display unit 10f displays various kinds of screens, and may be constructed by a liquid crystal display (LCD), for example. The display unit 10f may display a screen or the like for inputting computation details, for example.

The computation instruction program may be stored in a computer-readable storage medium such as the RAM 10b or the ROM 10c for provision, or may be provided via a communication network connected by the communication unit 10d. In the control device 10, the CPU 10a executes a computation instruction program to implement various kinds of operations described with reference to FIG. 1. These physical configurations are merely examples, and may not necessarily be independent configurations. For example, the control device 10 may include a large-scale integration (LSI) in which the CPU 10a, the RAM 10b, and the ROM 10c are integrated.

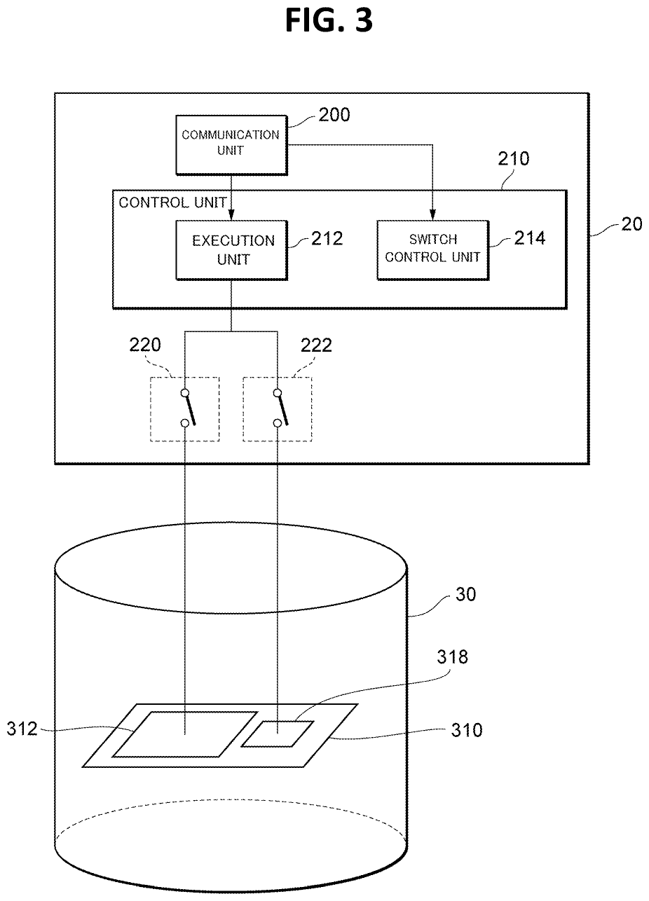

FIG. 3 is a schematic configuration diagram of the measurement device 20 and the refrigerator 30 according to this embodiment.

The measurement device 20 causes a computation unit to execute various kinds of computations. In this embodiment, the measurement device 20 can cause various kinds of computation units placed in the refrigerator 30 to execute computations based on an instruction from the instruction unit 126 of the control device 10. More specifically, the measurement device 20 causes the computation unit selected by the selection unit 124 to execute computation. The measurement device 20 includes a communication unit 200, a control unit 210, a first switch 220, and a second switch 222. The first switch 220 and the second switch 222 may be prepared as actual components, but the first switch 220 and the second switch 222 may simply be illustrations for convenience to facilitate understanding of the state selected by the selection unit 124. In other words, the first switch 220 and the second switch 222 may not be prepared as actual components.

The communication unit 200 is an interface for connecting the measurement device 20 to other devices. In this embodiment, the communication unit 200 is connected to the communication network 15. The communication unit 200 can transmit/receive various kinds of information. For example, the communication unit 200 receives an instruction or the like from the control device 10.

The control unit 210 executes various kinds of control. The control unit 210 may include a microcomputer or the like including a ROM, a RAM, and a CPU, for example. The control unit 210 includes an execution unit 212 and a switch control unit 214. The switch control unit 214 may be prepared as an actual component, but may simply be an illustration for convenience to facilitate understanding of the state selected by the selection unit 124. The general-purpose computation unit 312, the specific computation unit 318, and the execution unit 212 are connected by wiring for propagating electrical signals, such as phosphor bronze wiring, low resistance wiring made of Cu or NbTi/CuNi, high frequency wiring or a coaxial cable made of SCNi—CuNi, or the like. The switch control unit 214 is illustrated for convenience to control connection between the two computation units and the execution unit 212, but may be prepared as an actual component.

The execution unit 212 causes a computation unit to execute computation. Specifically, the execution unit 212 transmits various kinds of signals to a computation unit and causes the computation unit to execute computation based on an instruction from the control device 10. The execution unit 212 includes a signal generator. The signal generator is a device that generates various kinds of signals, and includes various kinds of devices such as an arbitrary waveform generator (AWG), an oscillator, and a DC power supply, for example. Further, the execution unit 212 may be placed inside the refrigerator 30.

The execution unit 212 can cause each computation unit to execute computation such that computations executed by the respective plurality of computation units selected by the selection unit 124 become synchronous to each other. Specifically, the execution unit 212 can manage the timing of computation by each of a plurality of computation units by adjusting the timing of inputting a signal to each computation unit. For example, the execution unit 212 can cause the plurality of computation units to start computations at the same timing.

Further, the execution unit 212 can cause each computation unit to execute computation such that computations executed by the respective plurality of computation units selected by the selection unit 124 become asynchronous to each other. For example, the execution unit 212 may cause the plurality of computation units to start computations at different timings.

The switch control unit 214 controls the states of the first switch 220 and the second switch 222, which are constructed by various kinds of publicly known switching devices, based on an instruction from the control device 10. Specifically, the switch control unit 214 controls a switch connected to a computation unit, which is to be caused to execute computation, to a conductive state, and controls a switch connected to a computation unit, which is not to be caused to execute computation, to an open state. For example, when a computation unit connected to the first switch 220 executes computation and a computation unit connected to the second switch 222 does not execute computation, the switch control unit 214 controls the first switch 220 to the conductive state, and controls the second switch 222 to the open state. The first switch 220, the second switch 222, and the switch control unit 214 may be prepared as actual components, but may simply be illustrations for convenience to facilitate understanding of the state selected by the selection unit 124. In other words, the first switch 220, the second switch 222, and the switch control unit 214 may not be prepared as actual components.

The refrigerator 30 is a refrigerator capable of achieving cryogenic temperatures, and may be, for example, a refrigerator using the ³He—⁴He dilution refrigeration method. The temperature inside the refrigerator 30 can be a temperature equal to or lower than 4 K (more precisely, 4.2 K, the boiling point of ⁴He liquid at atmospheric pressure). Further, the refrigerator 30 includes a board 310 adjusted to a predetermined temperature. In this embodiment, the temperature of the board 310 is the temperature of several mK to several tens of mK. The temperature of the board 310 is not limited thereto, and may be a temperature such as 4.2 K or 1 K, for example.

In this embodiment, the group of computation units includes a plurality of computation units formed on the same board 310. The computation unit has a superconducting material, and executes computation using quantum effects or thermal effects in the superconducting state. More specifically, the computation unit can execute computation using quantum annealing or other methods when the temperature of the computation unit is equal to or lower than the superconducting transition temperature of the superconducting material. The computation unit is connected to a readout circuit, and the result of computation and other information are read out as appropriate. The readout circuit is formed on the board 310, for example. The computation unit is not limited to quantum annealing, and for example, at least one of Ion trap, coherent ising machines, quantum gate devices, quantum dots, nitrogen vacancy (NV) centers, and topological insulators (majorana fermion), and the like may be used.

In this embodiment, the general-purpose computation unit 312, which is a computation unit for general purposes, and the specific computation unit 318, which is a computation unit for a specific purpose, are formed on the board 310. That is, in this embodiment, the group of computation units includes a general-purpose computation unit and a specific computation unit. When each of the general-purpose computation unit 312 and the specific computation unit 318 executes computation, it is assumed that the temperature of each of the general-purpose computation unit 312 and the specific computation unit 318 is set to the same temperature as that of the board 310.

Each of the general-purpose computation unit 312 and the specific computation unit 318 is electrically connected to the measurement device 20. Specifically, each of the general-purpose computation unit 312 and the specific computation unit 318 is connected to the first switch 220 and the second switch 222 of the measurement device 20 through a coaxial cable or a twisted pair cable. The first switch 220 and the second switch 222 are illustrations for convenience, and wiring for propagating electrical signals, such as a coaxial cable or a twisted pair cable connected to each of the general-purpose computation unit 312 and the specific computation unit 318, may be directly connected to the measurement device 20.

The general-purpose computation unit 312 may be, for example, a circuit with quantum gate devices or other components. In this case, a single board 310 is illustrated in FIG. 3, but a plurality of boards may be stacked or a plurality of boards may be bonded together. In this case, various configurations such as an interposer or a through silicon via (TSV) and bumps may be realized.

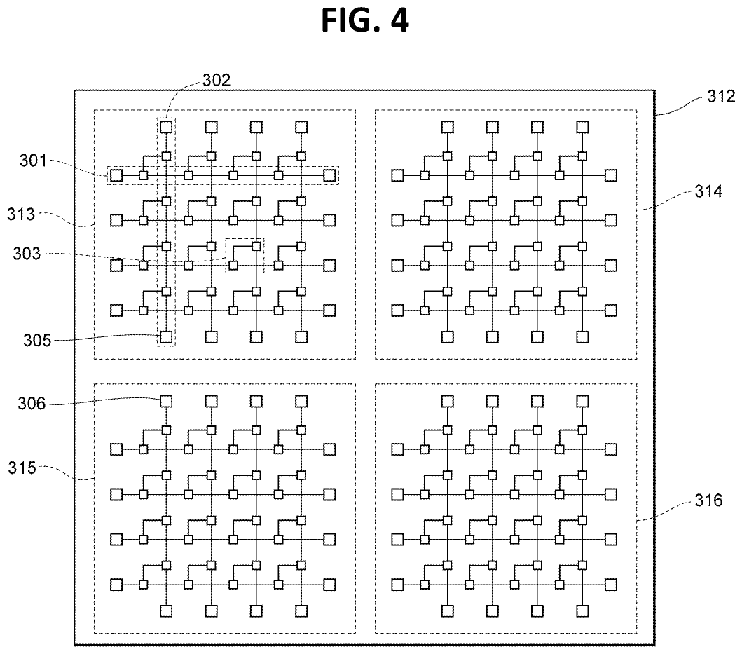

The specific computation unit 318 may include a circuit configuration appropriate for a specific purpose. For example, the specific computation unit 318 may include a circuit configuration appropriate for implementing a Hamiltonian corresponding to a problem to be solved. In this case, the circuit configuration of the specific computation unit 318 may include a plurality of lattices (for example, lattices as illustrated in FIG. 4) formed by quantum bits, for example. In this case, fixed connection may be used for connection between a plurality of quantum bits and between lattices forming the specific computation unit 318. In other words, connection between a plurality of quantum bits and between lattices forming the specific computation unit 318 may be fixed so as not to be changed.

The purpose of the specific computation unit 318 may be various kinds of purposes such as logical operation (for example, NOR operation, NAND operation, OR operation, and AND operation), multiplication, factorization, protein structure analysis, knapsack optimization problems, and portfolio optimization problems.

FIG. 4 is a schematic configuration diagram of the general-purpose computation unit 312 according to this embodiment. The general-purpose computation unit 312 according to this embodiment includes a chimera graph constructed by four lattices (first lattice 313, second lattice 314, third lattice 315, fourth lattice 316). Each lattice has a configuration in which four quantum bits are placed vertically and horizontally. In FIG. 4, four lattices are illustrated, but the number of lattices included in the general-purpose computation unit 312 may be equal to or smaller than 3 or equal to or larger than 5.

Specifically, each lattice includes four first quantum bits 301 extending horizontally, four second quantum bits 302 extending vertically, and sixteen variable couplers 303. The variable coupler 303 connects one first quantum bit 301 and one second quantum bit 302 to each other, and the connection may be adjusted appropriately. The first quantum bit 301 and the second quantum bit 302 interact with each other depending on connection by the variable coupler 303.

Each of the four first quantum bit 301 included in each lattice functions as a separate quantum bit. Each first quantum bit 301 is connected to another quantum bit by the variable coupler, and interacts with another quantum bit. Further, each of the four second quantum bits 302 included in each lattice functions as a separate quantum bit. Each second quantum bit 302 is connected to another quantum bit by the variable coupler, and interacts with another quantum bit.

Further, the edge of each quantum bit may be connected to the opposing edge of a quantum bit included in another lattice. For example, an edge 305 of the second quantum bit 302 in the left end of the first lattice 313 may be connected to an edge 306 of the second quantum bit in the left end of the third lattice 315. In this manner, a plurality of lattices are connected by connecting quantum bits, to thereby implement computation using a plurality of lattices.

The number of lattices to be used is adjusted appropriately depending on the computation details when the general-purpose computation unit 312 executes computation. For example, one lattice is used when the computation details require three quantum bits. Further, for example, four lattices are used when the computation details require seven quantum bits.

In this embodiment, the general-purpose computation unit 312 executes computation using a chimera graph, and in the computation using a chimera graph, a Hamiltonian corresponding to a problem to be solved by the user is set, and the Hamiltonian is mapped to the chimera graph. For example, when the set Hamiltonian H₁ is represented by H₁=Σₙ₌₃Jᵢⱼσᵢσⱼ+Σhᵢσⱼ, three quantum bits are required, and thus one lattice is used. Further, when the set Hamiltonian H₂ is represented by H₂=Σₙ₌₇Jᵢⱼσᵢσⱼ+Σhᵢσⱼ, for example, seven quantum bits are required, and thus three lattices are used. In the above equations, σᵢ represents the spin of a site i, hᵢ represents the magnetic field of the site i, Jᵢⱼ represents an interaction between spins of the site i and the site j, and n represents the number of all sites.

Further, the general-purpose computation unit 312 includes one or a plurality of (for example, three) look up tables (LUTs), and may have a configuration capable of executing predetermined computation. When the general-purpose computation unit 312 includes a plurality of LUTs, at least two LUTs may be connected to each other among the plurality of LUTs. In this case, after the selection unit 124 selects the general-purpose computation unit 312, a screen for specifying computation details may be displayed on the display unit 105, and a mode of designing the computation details by the user may be selected. The instruction unit 126 instructs the general-purpose computation unit 312 to execute computation, and the general-purpose computation unit 312 executes computation in response to the user setting an LUT connection method (connection method among plurality of LUTs) according to the computation details.

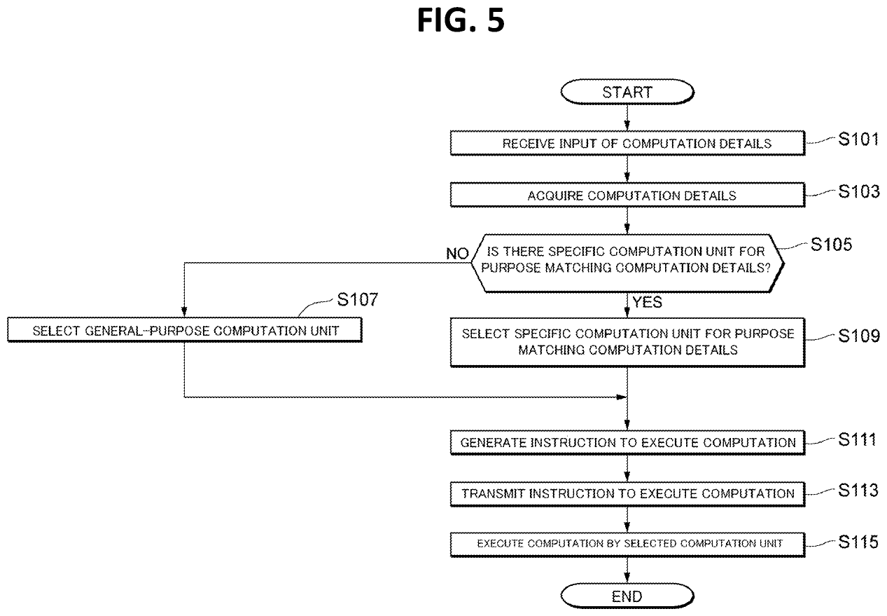

FIG. 5 is a flow chart illustrating a flow of processing to be executed by the computer system 1 according to this embodiment.

First, the input unit 110 receives input of computation details based on operation performed by the user (Step S101). Next, the acquisition unit 122 acquires the computation details received in Step S101 (Step S103).

Next, the selection unit 124 determines whether or not there is a specific computation unit for a purpose matching the computation details acquired in Step S103 (Step S105). When the selection unit 124 has determined that there is no specific computation unit for a purpose matching the computation details (Step S105: NO), the selection unit 124 proceeds to Step S107. On the other hand, when the selection unit 124 has determined there is a specific computation unit for a purpose matching the computation details (Step S105: YES), the selection unit 124 proceeds to Step S109.

When the determination results in NO in Step S105, the selection unit 124 selects a general-purpose computation unit from the group of computation units (Step S107). On the other hand, when the determination results in YES in Step S105, the selection unit 124 selects a specific computation unit for a purpose matching the computation details from the group of computation units (Step S109).

In response to the selection unit 124 selecting a computation unit in Step S107 or Step S109, the instruction unit 126 generates an instruction to execute computation by the selected computation unit (Step S111). Next, the communication unit 130 transmits an instruction to execute computation by the selected computation unit to the measurement device 20 via the communication network 15 (Step S113). Next, the communication unit 200 of the measurement device 20 receives the instruction, and the execution unit 212 causes the selected computation unit to execute computation based on the received instruction (Step S115). As a result, the computation unit placed in the refrigerator 30 executes computation according to the computation details. After the computation unit has executed computation, the processing illustrated in FIG. 5 is finished. Although specific description is omitted here, the computation result may be observed by a measurement device (not shown) responsible for observing the state (reading the state) of the measurement device 20, and transmitted to the control device 10 via the communication network 15. Further, the computation result may be displayed on the display unit 105 or stored in the storage unit 100.

### EXAMPLE 1

In an example 1, an experiment was conducted under a state in which two computation units were placed in the refrigerator 30. In this example, the two computation units were a computation unit (hereinafter also referred to as “NOR unit”) that executed NOR operation and a computation unit (hereinafter also referred to as “multiplier unit”) that executed multiplication. In this example, each of the NOR unit and the multiplier unit was cooled to 10 mK in the refrigerator 30, and each of the NOR unit and the multiplier unit was caused to execute computation under the superconducting state. In this example, “LabVIEW (registered trademark)”, which is the software installed in the control device 10, was used for giving an instruction to select a computation unit (select NOR unit or multiplier unit) and execute computation by the computation unit, for example.

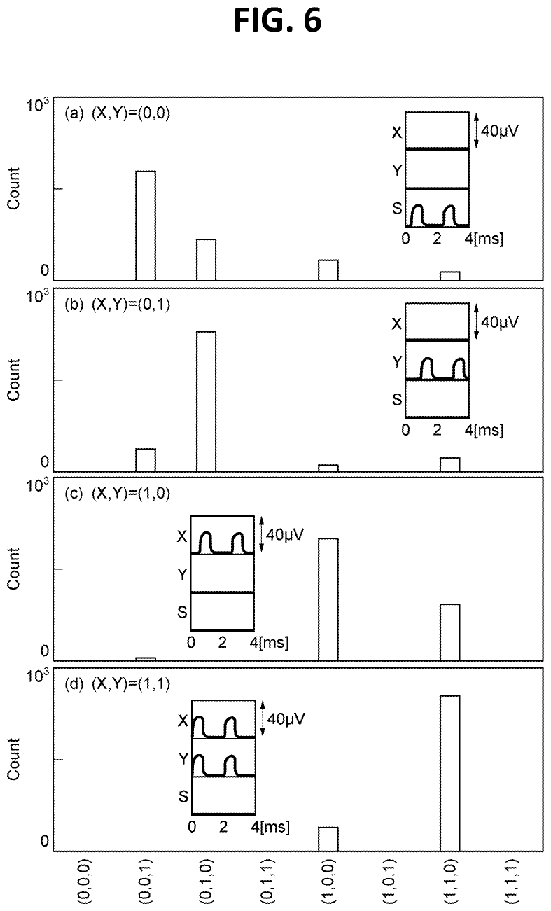

FIG. 6 is a diagram illustrating the result of NOR operation by a NOR unit in the example 1. In this example, the NOR unit each executed NOR operation 1000 times for each of inputs (0, 0), (0, 1), (1, 0), and (1, 1). FIG. 6 shows the graphs of four computation results, and the computation results for the inputs (0, 0), (0, 1), (1, 0), and (1, 1) are shown in order from the above in the stated order. X and Y of FIG. 6 represent an input (X, Y), and S represents a computation result. Further, the horizontal axis of the graph is represented by (X, Y, S), and the vertical axis thereof indicates the count of computation results. As shown in FIG. 6, every computation resulted in the greatest count of correct computation results. Therefore, it can be said that the NOR unit executed computation appropriately in this example.

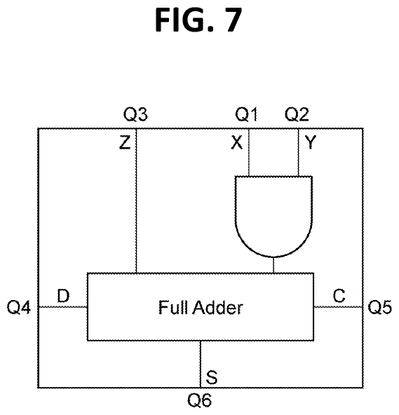

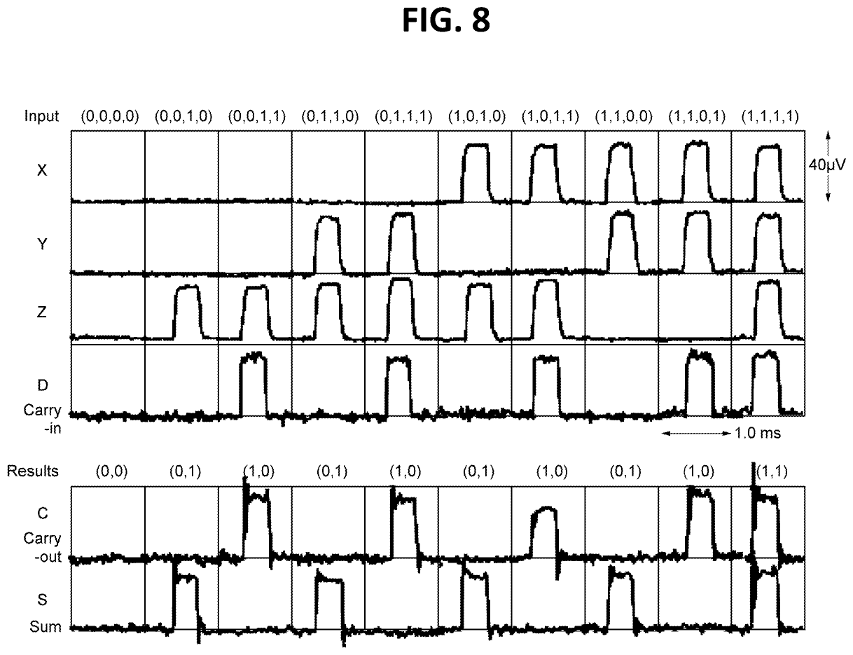

Next, referring to FIG. 7 and FIG. 8, description is given of the result of computation by a multiplier unit. FIG. 7 is a diagram for describing computation details of the multiplier unit in the example 1. Each of X, Y, Z, and D shown in FIG. 7 corresponds to an input of the multiplier unit. Further, C and S correspond to the results of computation by the multiplier unit. The circuit illustrated in FIG. 7 is the schematic illustration of a relationship between an input and output of the multiplier unit, and X, Y, Z, D, C, and S are implemented by quantum bits Q1 to Q6, respectively.

FIG. 8 is a diagram illustrating the result of multiplication by the multiplier unit in the example 1. FIG. 8 shows the results (C, S) of computation for inputs (X, Y, Z, D). In this example, the multiplier unit executed multiplication with (0, 0, 0, 0) to (1, 1, 1, 1) as inputs. As shown in FIG. 8, every computation resulted in appropriate computation results.

In this example, a computation unit was selected according to computation details from a group of computation units including two computation units, namely, a NOR unit and a multiplier unit, and the selected computation unit executed computation. As a result, every computation unit executed computation appropriately.

### EXAMPLE 2

In an example 2, a simulation of computation executed by each of the NOR unit and the multiplier unit in the first example was conducted.

First, a simulation of computation executed by the NOR unit was conducted. Specifically, a circuit corresponding to each of loops forming three quantum bits was prepared, and currents (Iₕ₁, Iₕ₂, Iₕ₃) were caused to flow through current lines having parts extending parallel to the circuits and generate magnetic fluxes, to thereby induce a critical current to flow through each loop of the three quantum bits. The quantum bits interacted with each other such that the computation results (critical currents I_{q1}, I_{q2}, I_{q3} flowing through respective loops) had a NOR relationship. In this circuit simulation, Iₕ₁, Iₕ₂, Iₕ₃ caused different critical currents to flow through respective quantum bits. In other words, it can also be said that the magnetic flux induced by flowing Iₕ₁ and Iₕ₂ caused an input to the NOR unit, and Iₕ₃ produced a magnetic flux for inducing a current for observing an output. Then, the state (0 or 1) of a quantum bit was measured based on whether or not the value of a current (hereinafter also simply referred to as “quantum bit current”) flowing through the loop of each quantum bit exceeded a threshold value via a readout circuit connected to the loop of each quantum bit.

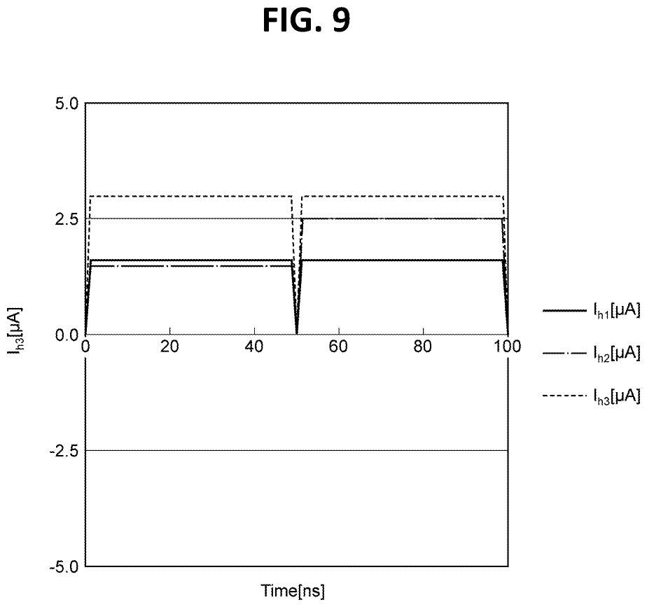

FIG. 9 is a diagram illustrating currents (Iₕ₁, Iₕ₂, Iₕ₃) flowing through three circuits in simulation of the example 2. The computation of (1, 1, 0) was simulated in 0 to 50 ns, and the computation of (1, 0, 0) was simulated in 50 to 100 ns. In 0 to 50 ns, the currents Iₕ₁, Iₕ₂, Iₕ₃ were caused to flow through respective current lines having parts extending parallel to the three quantum bits so as to implement the computation of (1, 1, 0). In 50 to 100 ns, the currents Iₕ₁, Iₕ₂, Iₕ₃ were caused to flow through respective current lines having parts extending parallel to the three quantum bits so as to implement the computation of (1, 0, 0).

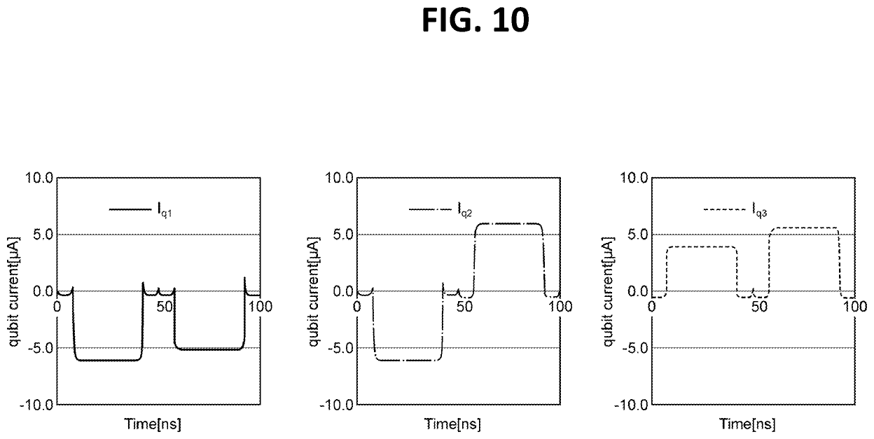

FIG. 10 is a diagram illustrating currents flowing through the three quantum bit loops in simulation of the example 2. The three graphs shown in FIG. 10 are graphs showing the currents I_{q1}, I_{q2}, and I_{q3} of quantum bits corresponding to circuits through which the currents Iₕ₁, Iₕ₂, and Iₕ₃ flow in order from the left. In this example, the state (0 or 1) of a quantum bit was measured by setting 0 μA as a threshold value. Specifically, when the current value of a quantum bit was smaller than 0 μA, the quantum bit was measured to be 1, whereas when the current value of a quantum bit was equal to or larger than 0 μA, the quantum bit was measured to be 0. It is understood from the state of each quantum bit read from FIG. 10 that the states of the three quantum bits were (1, 1, 0) in 0 to 50 ns, and the states of the three quantum bits were (1, 0, 0) in 50 to 100 ns. Therefore, it is understood that the computation of the NOR unit was reproduced appropriately. In this example, the computation was simulated in the order of ns to reduce the period of simulation. Besides, it is also confirmed that the computation of the NOR unit was reproduced appropriately when the computation was simulated in the order μs.

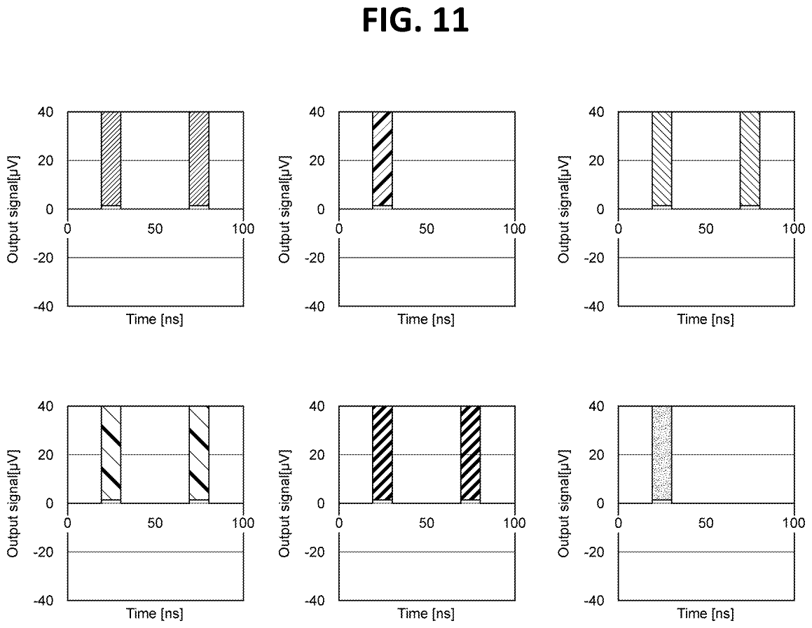

FIG. 11 is a diagram illustrating the result of executing simulation reproducing the computation of the multiplier unit in the example 2. The upper graphs show the states of quantum bits Q1 to Q3 in order from the left, and the lower graphs show the states of quantum bits Q4 to Q6 in order from the left. In this simulation, computation was executed so as to output a positive voltage if the state of a quantum bit was 1 when the state of the quantum bit was read. The Q1 to Q6 shown in FIG. 11 correspond to Q1 to Q6 shown in FIG. 7. That is, Q1 to Q4 are inputs, and Q5 and Q6 are calculation results. In the example 2, the computation with (1, 1, 1, 1) as an input was simulated in 0 to 50 ns, and the computation with (1, 0, 1, 1) as an input was simulated in 50 to 100 ns. Referring to FIG. 11, the computation result was (1, 1) in 0 to 50 ns, and the computation result was (1, 0) in 50 to 100 ns. It is understood that multiplication was reproduced appropriately. In this example, the computation was simulated in the order of ns to reduce the period of simulation. Besides, it is also confirmed that the computation of the multiplier unit was reproduced appropriately when the computation was simulated in the order μs.

### Effect

According to this embodiment, the computer system 1 selects a computation unit from the group of computation units, and causes the selected computation unit to execute computation. In this manner, the necessity for reconfiguration according to the computation details in the circuit configuration of a quantum computer is reduced.

Further, according to this embodiment, the group of computation units includes a specific computation unit in addition to the general-purpose computation unit. Thus, a redundant bit that is required at the time of creating a subject circuit by mapping the function to the general-purpose computation unit is not required.

Further, according to this embodiment, the instruction unit 126 can give an instruction indicating the number of times of computation to be executed by the computation unit. In this case, the amount of increase in power consumption due to increase in number of times of computation may be reduced compared to the amount of increase in power consumption of a classical computer.

Further, according to this embodiment, when there is a specific computation unit for a purpose matching the computation details acquired by the acquisition unit 122, the specific computation unit is selected, whereas when there is no specific computation unit for a purpose matching the computation details, the general-purpose computation unit is selected. In this manner, an appropriate computation unit (for example, general-purpose computation unit) is selected even when there is no specific computation unit for a purpose matching computation details.

Further, according to this embodiment, each of a plurality of computation units selected by the selection unit 124 executes computation. In this manner, computation may be executed more efficiently.

Further, according to this embodiment, the computer system 1 can also set computations by a plurality of computation units to be synchronous to each other. In this case, the quantum computer is an analog computer, and thus the computer system 1 according to this embodiment is not required to design computation synchronized with a clock as in the case of synchronization of a classical computer.

Further, according to this embodiment, the computer system 1 can also set computations by a plurality of computation units to be asynchronous to each other. In this manner, it is possible to cause each of the plurality of computation units to execute computation at a freer timing.

Further, according to this embodiment, the group of computation units includes a plurality of computation units formed on the same board 310. Thus, design thereof becomes easier, or the plurality of computation units formed on the same board 310 can be wired more easily. Further, the latency of each computation unit, deviation in timing of computation, and the like are improved by forming a plurality of computation units on the same board.

### First Modification Example

In the above embodiment, description has been given on the assumption that all the computation units forming a group of computation units are formed on one board. However, the present invention is not limited thereto, and the group of computation units may include a plurality of computation units formed on different boards.

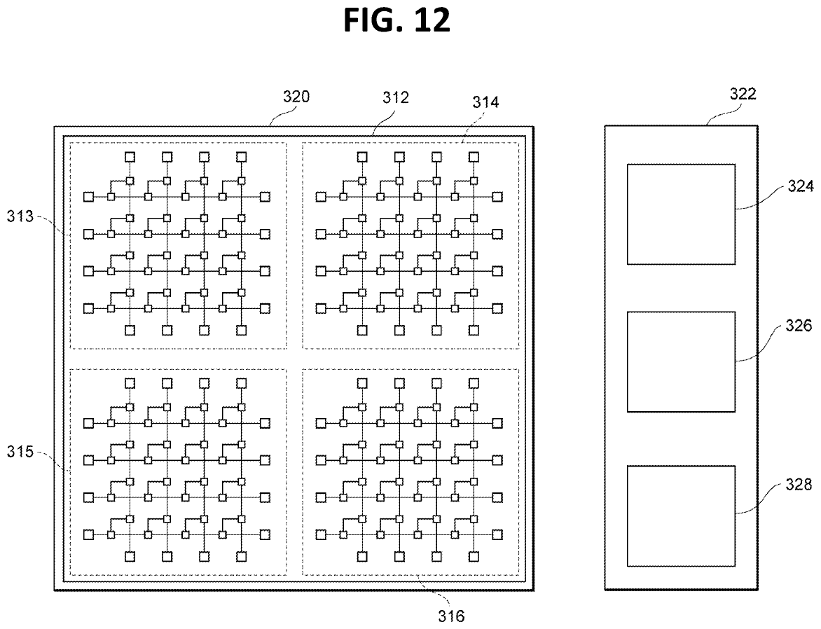

FIG. 12 is a diagram illustrating the configurations of two boards (first board 320 and second board 322) according to a first modification example. The general-purpose computation unit 312 is formed on the first board 320. Further, three specific computation units 324, 326, and 328 are formed on the second board 322. In this embodiment, the general-purpose computation unit 312 and the three specific computation units 324, 326, and 328 form a group of computation units.

In this embodiment, the table stored in the storage unit 100 associates each piece of information indicating each of the three specific computation units 324, 326, and 328 with information indicating a purpose thereof. The selection unit 124 can select a specific computation unit for a purpose matching computation details by referring to the table. In this case, the selection unit 124 can select a plurality of specific computation units. Alternatively, the selection unit 124 can also select the general-purpose computation unit 312 and at least one specific computation unit.

Further, in this embodiment, the execution unit 212 can cause each of a plurality of specific computation units to execute computation. For example, the execution unit 212 may cause one specific computation unit to execute computation of factorization while causing another specific computation unit to execute computation of protein analysis.

According to this embodiment, the group of computation units includes a plurality of specific computation units for different purposes. Further, the selection unit 124 can select a specific computation unit for a purpose matching computation details. In this manner, a specific computation unit for a purpose matching computation details more is selected from among the plurality of specific computation units. As a result, more appropriate computation is executed.

Further, according to this embodiment, the group of computation units includes a plurality of computation units formed on different boards. Thus, it is possible to place each board at a desired position according to the characteristics or the like of computation units formed on the boards.

In this embodiment, description has been given on the assumption that a plurality of computation units forming a group of computation units are placed on two boards. However, the present invention is not limited thereto, and a plurality of computation units forming a group of computation units may be placed on three or more boards.

Further, in this embodiment, description has been given on the assumption that three specific computation units are formed on the second board 322. Alternatively, four or more specific computation units may be formed on one board, or two or less specific computation units may be formed on one board. Further, two or more general-purpose computation units may be placed on one board.

### Second Modification Example

Further, in the first modification example, description has been given of an example of forming a computation unit on each of a plurality of boards. When a plurality of boards are placed in the refrigerator 30, each board may be placed in a different temperature region.

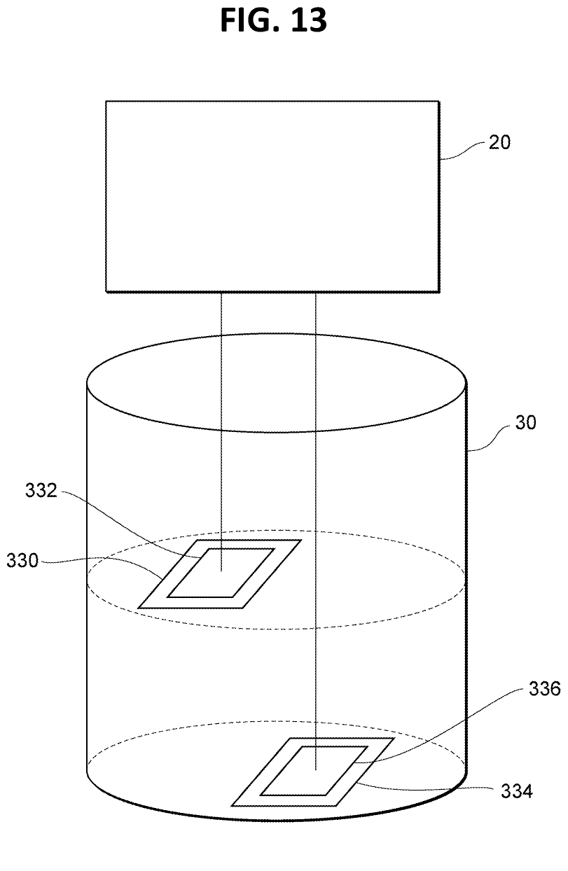

FIG. 13 is a diagram illustrating the internal configuration of the refrigerator 30 according to a second modification example. Two boards (first board 330 and second board 334) are placed in different temperature regions of the refrigerator 30. It is assumed that a first computation unit 332 including a quantum annealing device is formed on the first board 330, and a second computation unit 336 including a quantum gate device is formed on the second board 334.

In this example, it is assumed that the internal configuration of the refrigerator 30 is designed such that the temperature of the refrigerator 30 decreases gradually downward. In other words, the temperature of the refrigerator 30 becomes lower as the position thereof becomes lower inside the refrigerator 30.

In this embodiment, the first computation unit 332 and the second computation unit 336 are formed on boards of different temperatures. That is, each of the first board 330 and the second board 334 is attached to a stage (not shown) provided in a different temperature region. As a result, the temperatures of the first board 330 and the second board 334 are different temperatures, and the temperatures of the first computation unit 332 and the second computation unit 336 are also different temperatures. The temperatures of the first computation unit 332 and the second computation unit 336 are also different temperatures when the respective computation units execute computations.

Further, in this embodiment, the second board 334 is placed at a position lower than that of the first board 330. Thus, the temperature of the second board 334 is lower than the temperature of the first board 330. As a result, the temperature of the second computation unit 336 is lower than the temperature of the first computation unit 332.

More specifically, the first board 330 is attached to the stage of a temperature region of about 0.1 K. Thus, the temperatures of the first board 330 and the first computation unit 332 are the temperature of about 0.1 K. As a result, the quantum annealing device included in the first computation unit 332 becomes the superconducting state, and the quantum effect appears in the quantum annealing device. In this case, the first computation unit 332 can execute computation using quantum effects or thermal effects in the superconducting state, and thus it can be said that the first computation unit 332 is formed on the first board 330 of a temperature appropriate for computation.

On the other hand, the second board 334 is attached to the stage of the region of a temperature lower than 10 mK. The second computation unit 336 formed on the second board 334 includes a quantum gate device, which enables computation using quantum effects or thermal effects of the superconducting state at the temperature lower than 10 mK. Thus, it can be said that the second computation unit 336 is formed on the second board 334 of a temperature appropriate for computation.

The area for setting a 10 mK temperature region is limited inside the refrigerator 30. Computation units such as the second computation unit 336 are required to be placed in the 10 mK temperature region. In view of this, it is possible to efficiently utilize space inside the refrigerator 30 by placing, in the region of a temperature higher than 10 mK, the first computation unit 332 capable of executing computation appropriately at the temperature (for example, 0.1 K) higher than 10 mK.

An Si quantum dot device or the like capable of performing unitary operation may be placed in the 10 mK temperature region as a quantum bit. Further, in the 10 mK temperature region, devices such as topological insulators of different quantum calculation methods, such as those that use braid theory, may be placed.

Further, in this embodiment, description has been given on the assumption that the number of computation units formed on boards of different temperatures is two. However, the present invention is not limited thereto, and the number of computation units formed on boards of different temperatures may be three or more.

### Third Modification Example

In the above embodiment, description has been given on the assumption that one measurement device 20 causes computation units to execute computations. However, the present invention is not limited thereto, and two or more measurement devices may cause the computation units to execute computations.

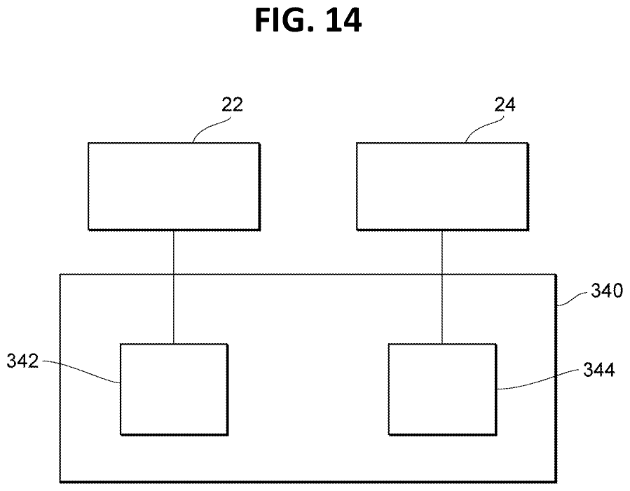

FIG. 14 is a diagram illustrating the configurations of two measurement devices (first measurement device 22 and second measurement device 24) and a board 340 according to a third modification example. In FIG. 14, a refrigerator is omitted. It is assumed that each of the first measurement device 22 and the second measurement device 24 has substantially the same function as the measurement device 20 illustrated in FIG. 3, and is communicably connected to the control device 10.

Two computation units (first computation unit 342 and second computation unit 344) are formed on the board 340. The first computation unit 342 is connected to the first measurement device 22, and the second computation unit 344 is connected to the second measurement device 24. Therefore, the first measurement device 22 can cause the first computation unit 342 to execute computation, and the second measurement device 24 can cause the second computation unit 344 to execute computation.

In this case, the first measurement device 22 and the second measurement device 24 can cause each of the first computation unit 342 and the second computation unit 344 to execute computation such that computations executed by the first computation unit 342 and the second computation unit 344 become synchronous to each other. For example, signals serving as triggers may be input to the first measurement device 22 and the second measurement device 24. In this case, the first measurement device 22 and the second measurement device 24 cause the first computation unit 342 and the second computation unit 344 to execute computations in response to reception of the triggers. As a result, the computations executed by the first computation unit 342 and the second computation unit 344 become synchronous to each other. The signals serving as triggers may be generated by, for example, the instruction unit 126 of the control device 10, and transmitted to the first measurement device 22 and the second measurement device 24.

The first measurement device 22 and the second measurement device 24 can also cause each of the first computation unit 342 and the second computation unit 344 to execute computation such that the computations executed by the first computation unit 342 and the second computation unit 344 become asynchronous to each other.

In this embodiment, description has been given of an example in which the number of measurement devices is two. Alternatively, the number of measurement devices may be three or more. Further, the number of computation units connected to one measurement device may be two or more.

### Fourth Modification Example

In the above embodiment, description has been given on the assumption that each computation unit executes computation in the superconducting state in the refrigerator 30. The computation unit is not limited to a device that executes computation in the superconducting state, and for example, may be a device or the like capable of executing computation in a room temperature.

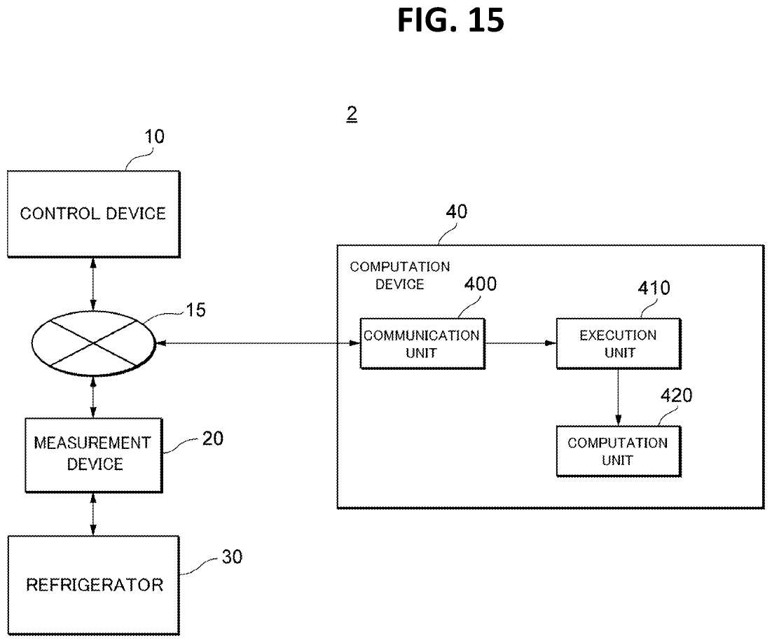

FIG. 15 is a schematic configuration diagram of a computer system 2 according to a fourth modification example. The computer system 2 includes a computation unit 40 in addition to the control device 10, the measurement device 20, and the refrigerator 30 included in the computer system 1 described with reference to FIG. 1.

The computation unit 40 executes various kinds of computations that do not depend on the superconducting state according to an instruction given by the control device 10. In this embodiment, it is assumed that the computation unit 40 can execute computation in the room temperature, for example. The computation unit 40 includes a communication unit 400, an execution unit 410, and an computation unit 420.

The communication unit 400 is an interface for connecting the control device 10 to other devices. The communication unit 400 may be connected to a communication network such as a LAN, a WAN, or the Internet. Further, the communication unit 400 may connect to another device (for example, control device 10) via a USB cable, a GPIB cable, or other cables. The communication unit 400 can transmit/receive various kinds of information. For example, the communication unit 400 can receive an instruction to execute computation by a computation unit from the control device 10. The communication unit 400 transmits the received information to the execution unit 410.

The execution unit 410 may include a microcomputer or the like including a ROM, a RAM, a CPU, and other components. Further, the execution unit 410 may have various kinds of configurations of the execution unit 212 included in the measurement device 20.

The execution unit 410 causes a computation unit to execute various kinds of computations. Specifically, the execution unit 410 causes various kinds of computation units included in the computation unit 420 to execute computations based on an instruction given by the control device 10.

The computation unit 420 includes various kinds of computation units, and executes various kinds of computations according to control by the execution unit 410. The computation units included in the computation unit 420 may be general-purpose computation units or specific computation units.

The computation unit can be, for example, an LUT-based Field-Programmable Gate Array (FPGA), a workstation, an optical coherent ising machine, or an ising machine operated by an Application Specific Integrated Circuit (ASIC), which can execute logical operation efficiently. The FPGA may be used as a general-purpose computation unit or a specific computation unit. Further, the computation unit may include a device that implements non-von Neumann computing (for example, ising machine and machine learning) on the FPGA. Further, the computation unit may execute computation such as simulated annealing. Further, the computation unit may be a circuit simulator that simulates computations of various kinds of computation units that execute computations in the superconducting state such as the NOR unit described above.

The computation unit included in the computation unit 40 and the computation unit placed in the refrigerator 30 may be a combination of only specific computation units, a combination of a specific computation unit and a general-purpose computation unit, or a combination of only general-purpose computation units.

Further, the specific computation unit included in the computation unit 40 may be provided in a macro form in Intellectual Property (IP) cores, and constructed by various kinds of circuits according to the purpose of computation. For example, the circuit may be constructed by an electronic circuit simulator called Simulation Program with Integrated Circuit Emphasis (SPICE), and the specific computation unit may output the result of computation by the circuit.

### Other Embodiments

In the above embodiment, description has been given on the assumption that a computation unit placed outside of the control device 10 executes various kinds of computations. However, the present invention is not limited thereto, and the control device 10 may include a computation unit, and the computation unit may execute computation. In this case, the selection unit 124 can select a computation unit included in the control device 10 or a computation unit (for example, specific computation unit) placed outside of the control device 10. For example, when a computation unit for a purpose matching computation details is placed outside of the control device 10, the selection unit 124 can select the computation unit placed outside of the control device 10.

In the above embodiment, description has been given on the assumption that the control device 10, the measurement device 20, and the computation unit 40 are mainly communicably connected to one another via the communication network 15. However, the present invention is not limited thereto, and the control device 10, the measurement device 20, and the computation unit 40 may be communicably connected to one another without intervention of the communication network 15.

In the above embodiment, description has been given on the assumption that the acquisition unit 122 mainly receives computation details directly. However, the present invention is not limited thereto, and the acquisition unit 122 may estimate and acquire computation details based on information (for example, Hamiltonian) on the computation details. Further, the acquisition unit 122 may acquire computation details based on a program identifying predetermined computation details.

The embodiments described above are intended to facilitate understanding of the present invention and are not intended to be interpreted as limiting the present invention. The components included in the embodiments and the placement, materials, conditions, shapes, sizes, and the like thereof are not limited to those shown in the examples and may be changed appropriately. Further, components shown in different embodiments may be partially replaced or combined.

### REFERENCE SIGNS LIST

1, 2 Computer system
10 Control device
100 Storage unit
110 Input unit
120 Processing unit
122 Acquisition unit
124 Selection unit
126 Instruction unit
128 Display control unit
20 Measurement device
210 Control unit
212 Execution unit
214 Switch control unit
220 First switch
222 Second switch

### 30 Refrigerator

### 310 Board

312 General-purpose computation unit
318, 324, 326, 328 Specific computation unit
40 Computation unit
410 Execution unit
420 Computation unit

1. A computer system comprising:
an acquisition unit that acquires computation details;
a group of computation units including a plurality of computation units each configured to execute computation using quantum effects or thermal effects in a superconducting state;
a selection unit that selects a computation unit from the group of computation units based on the computation details; and
an execution unit that causes the computation unit selected by the selection unit to execute computation.

2. The computer system according to claim 1,
wherein the group of computation units includes a general-purpose computation unit that is a computation unit for general purposes and a specific computation unit that is a computation unit for a specific purpose, and
wherein the selection unit selects the general-purpose computation unit if the group of computation units does not include a specific computation unit for a purpose matching the computation details, and selects the specific computation unit if the group of computation units includes a specific computation unit for a purpose matching the computation details.

3. The computer system according to claim 1,
wherein the group of computation units includes a plurality of specific computation units for different purposes, and
wherein the selection unit selects a specific computation unit for a purpose matching the computation details.

4. The computer system according to claim 1, wherein the group of computation units includes a plurality of computation units formed on the same board.

5. The computer system according to claim 1, wherein the group of computation units includes a plurality of computation units formed on different boards.

6. The computer system according to claim 5,
wherein the plurality of computation units formed on different boards include a plurality of computation units formed on boards of different temperatures, and
wherein each of the plurality of computation units formed on the boards of different temperatures is formed on a board of a temperature appropriate for computation by each computation unit.

7. The computer system according to claim 1,
wherein the selection unit selects a plurality of computation units from the group of computation units, and
wherein the execution unit causes each of the plurality of computation units selected by the selection unit to execute computation.

8. The computer system according to claim 7, wherein the execution unit causes each of the plurality of computation units selected by the selection unit to execute computation such that computations executed by the respective plurality of computation units selected by the selection unit become asynchronous to each other.

9. The computer system according to claim 7, wherein the execution unit causes each of the plurality of computation units selected by the selection unit to execute computation such that computations executed by the respective plurality of computation units selected by the selection unit become synchronous to each other.

10. A control device comprising:
an acquisition unit that acquires computation details; and
a selection unit that selects, based on the computation details, a computation unit from a group of computation units including a plurality of computation units each configured to execute computation using quantum effects or thermal effects in a superconducting state.

11. The control device according to claim 10,
wherein the group of computation units includes a general-purpose computation unit that is a computation unit for general purposes and a specific computation unit that is a computation unit for a specific purpose, and
wherein the selection unit selects the general-purpose computation unit if the group of computation units does not include a specific computation unit for a purpose matching the computation details, and selects the specific computation unit if the group of computation units includes a specific computation unit for a purpose matching the computation details.

12. The control device according to claim 10,
wherein the group of computation units includes a plurality of specific computation units for different purposes, and
wherein the selection unit selects a specific computation unit for a purpose matching the computation details.
